(19) United States
(12) Patent Application Publication
(10) Pub. No.: US 2011/0058515 A1
(43) Pub. Date: Mar. 10, 2011

(54) DATA AND TELEPHONY SATELLITE NETWORK WITH MULTIPLE PATHS

(75) Inventors: NAIM SHAHAB, Concord, CA (US); Mark Alan Pendergraft, Concord, CA (US)

(73) Assignee: Frysco, Inc.

(21) Appl. No.: 12/555,810

(22) Filed: Sep. 9, 2009

(51) Int. Cl. H04B 7/185

(52) U.S. Cl. 370/316

(57) ABSTRACT

A satellite network communicates data packets between a local handset and a remote handset in order to establish telephone communication between the handsets. The satellite network has a primary LEO satellite that receives said data packets from the local handset, and various communication links between the primary LEO satellite and the remote handset. When the data packets are received from the local handset, the primary LEO satellite concurrently transmits the data packets in their entirety through each of the communication paths to the remote handset. When the data packets are received, the remote handset identifies and discards duplicate data packets that are not needed.

### BACKGROUND OF THE INVENTION

The present invention relates generally to satellite communication systems and methods and more specifically to satellite communication systems and methods for transferring data between local and remote users.

Satellite communication systems have become indispensable, and now find use in marine and automobile navigation, telephonic communication, television data distribution and the like. In telephonic communication, satellite systems can communicate with remote regions that are inaccessible to cellular towers, and can assist in emergencies such as natural disasters where other terrestrial telephonic systems have been disrupted.

A typical satellite consists of a constellation of satellites orbiting around the earth. Iridium, for example, consists of a constellation of 66 satellites rotating around the earth's orbit. Another well know satellite system is Globalstar.

One limitation of existing satellite telephonic systems is that it is cost prohibitive to place or receive satellite telephonic calls. In part, this cost prohibitive nature can be attributed to the high cost of deploying these communication satellites into orbit. The high cost can also be attributed to bandwidth utilization inefficiencies. Each satellite telephonic call uses a dedicated channel. This dedicated channel cannot be used by other users even when voice information is not being communicated, resulting in bandwidth inefficiencies that can increase overall costs.

A further limitation of existing satellite telephonic systems is that physical obstacles (mountains, buildings, etc.) can prevent signals from reaching their intended recipients. Users frequently experience dropped calls and other data losses since line-of-site access to satellites is usually required for continuous communication between such users.

Thus, there is a need to address one or more of the aforementioned problems and the present invention meets this need.

### BRIEF SUMMARY OF THE INVENTION

Various aspects of a satellite communication network for communicating data packets during telephone communication between a local user handset and a remote user handset can be found in the present invention.

In one aspect, the satellite communication network includes the local user handset in communication with a first satellite referred to as the primary Low Earth Orbit (LEO) Satellite. This primary LEO satellite is configured to receive data packets from the local user handset. Here, the data packets can be the user's analog voice signal that is packetized and formatted for transmission during telephonic conversation.

Data packets might also include audio, video, text and the like. Upon receiving the data packets, the primary LEO satellite concurrently transmits the data packets in their entirety through each of a plurality of communication paths between the primary LEO satellite and the remote handset. By using a plurality of communication paths for data transmission, the present invention provides path diversity and redundancy so as to avoid dropped telephonic calls and data losses associated with conventional satellite systems.

The plurality of communication paths includes a first path from the primary LEO satellite through a second LEO satellite to the remote handset. A second communication path also extends from the primary LEO satellite through the second LEO satellite as well as a second Geostationary Earth Orbit (GEO) satellite to the remote user handset. Further yet, a third communication path extends also from the primary LEO satellite via a first GEO satellite through the second GEO satellite to the remote handset. Further yet, a fourth communication link extends also from the primary LEO satellite via the Internet through the second GEO satellite to the remote user handset.

Therefore, the present invention permits the entirety of all of the data packets to be streamed through each of a plurality of communication paths. Not only does this provide redundancy and path diversity in the event of data loss, it also allows for increased throughput for bandwidth intensive data. Moreover, because data packets are not streamed through dedicated channels, the overall cost of using the present invention for satellite telephonic communication is reduced.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 shows a satellite network according to an exemplary embodiment of the present invention.

FIG. 2 is a block diagram illustrating components of a local user handset in accordance with an exemplary embodiment of the present invention.

FIGS. 3A & 3B illustrate a communication method according to an exemplary embodiment of the present invention.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, numerous specific details are set forth in order to provide a thorough understanding. However, it will be obvious to one of ordinary skill in the art that the present invention may be practiced without these specific details. In other instances, well known aspects have not been described in detail as not to obscure aspects of the present invention.

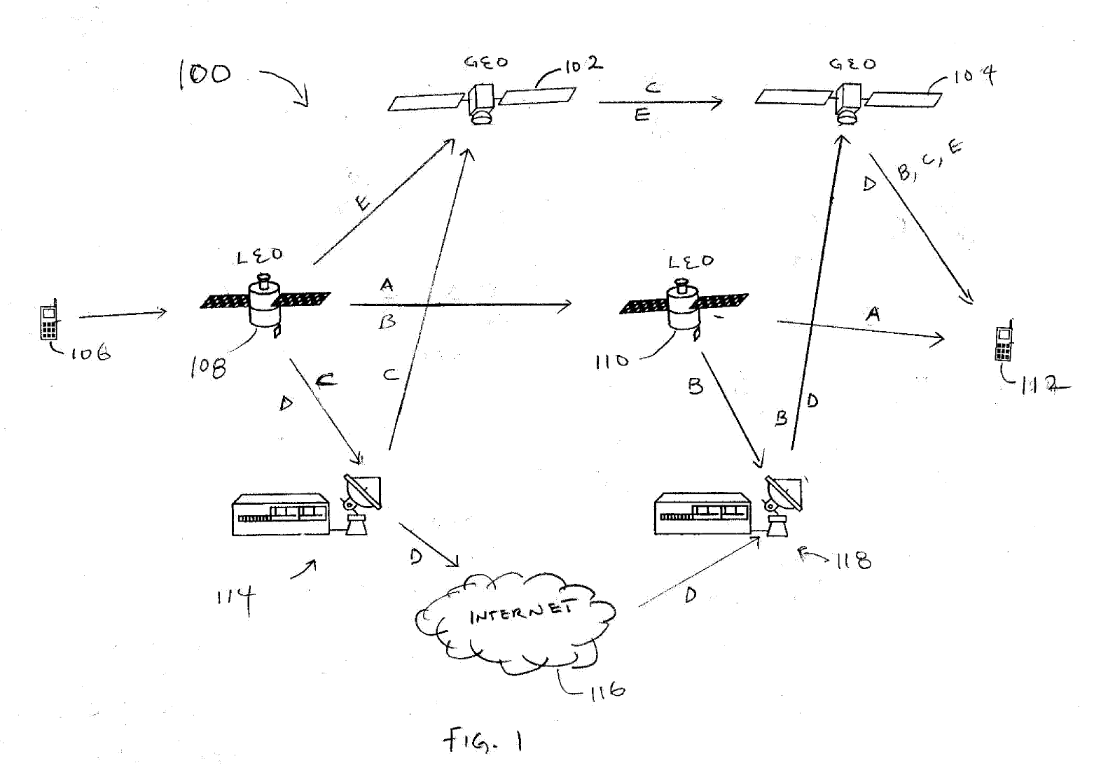

FIG. 1 shows satellite network 100 according to an exemplary embodiment of the present invention.

In FIG. 1, local user handset 106 can utilize satellite network 100 to establish telephone communication with remote user handset 112 located in separate geographic location. Local user handset 106 might be in San Francisco while remote user handset 112 is located in Moscow, for example. Both user handsets, however, might be in the same geographic location and need not be in separate geographic locations.

Note that as used herein both local user handset 106 and remote user handset 112 are stand alone wireless communication devices. Once telephonic communication is established between the user handsets, data packets can be streamed and exchanged between both user handsets via satellite network 100. Among other advantages, the present invention permits all information including voice, images video, audio, textual and the like to be streamed as data packets.

In FIG. 1, satellite network 100 comprises primary Low Earth Orbit (LEO) satellite 108. Primary LEO satellite 108 is configured to receive data packets from local user handset 106, and is configured to concurrently communicate said data packets via a plurality of communication paths A, B, C, D and E to remote user handset 112. As implied by its name, primary LEO satellite 108 is part of a constellation of low earth orbiting satellites, with an orbit range of about 500 miles above the earth's surface.

Preferably, every position on the earth's surface is locatable by any one or more of the LEO satellites. Primary LEO satellite 108 has multiple spot beams for transmitting and receiving, and each spot beam covers a predetermined geographic region. Local user handset 106 can be found within one such spot beam and is able to communicate with primary LEO satellite 108 via an appropriate frequency band (e.g. C band) within the spot beam.

Primary LEO satellite 108 is itself communicably linked to secondary LEO satellite 110 along communication paths A and B. Secondary LEO satellite 110 is also a low earth orbiting satellite orbiting at about 500 miles above the earth's surface. Secondary LEO satellite 110 is the closest LEO satellite to remote user handset 112 and is thus configured to deliver data packets received from primary LEO satellite 108 to remote user handset 112 along communication path A as shown. Although not shown, both LEO satellites have a switching means for establishing intersatellite link (communication path A) between primary LEO satellites 106 and secondary LEO satellite 110.

Secondary LEO satellite 110 is also configured to communicate data packets from primary LEO satellite 108 to gateway 118 along communication path B as shown. Gateway 118 comprises a hub and applicable computer software and hardware for receiving and translating data packets between applicable protocols as well as routing the data packets. As shown, gateway 118 which also includes a transmitter is communicably coupled to secondary Geosynchronous Earth Orbiting (GEO) satellite 104 also along communication paths B and D.

Secondary GEO satellite 104 is part of a constellation of satellites orbiting the earth at about 22,000 miles above the earth's surface. Secondary GEO satellite 104 is configured to forward data packets received from gateway 118's transmitter to the intended recipient namely remote user handset 112 along communication path B. Typically, secondary GEO satellite 104 is the closest GEO satellite to remote user handset 112. Preferably, secondary GEO satellite 104 is compliant with the standards set forth in DVB-S, developed by ETSI (European Telecommunications Standards Institute).

Many conventional satellite communications systems are being made compliant with DVB-S. Although originally intended for digital satellite broadcasting, the DVB-S standard is increasingly being utilized for IP (Internet Protocol) and TCP/IP more specifically. The DVB-S standard employs MPEG-2 (Motion Pictures Expert Group), which is another digital standard. MPEG-2 allows digital data carried by DVB-S communication systems to be compressed and packetized. Use of DVB-S thus allows for easy transfer of signals between mediums that would otherwise be incompatible. If signals can be digitized, DVB-S is capable of delivering such signals.

To transfer information, data packets or datagrams are placed within the payload sections of one or more MPEG-2 packets after which the MPEG-2 packets are transported using DVB-S. The portion of DVB-S that allows such packetization using a DVB carrier is referred to as MPE (Multi Protocol Encapsulation). MPE can be employed for transmitting IP packets for satellite-based communications as well as Voice Over IP communications.

Referring now to FIG. 1, primary LEO satellite 108 is also communicably linked to gateway 114 along communication paths C and D. Gateway 114 comprises a hub and applicable computer software and hardware for receiving and translating said data packets between applicable protocols as well as routing the data packets. As shown, gateway 114 is capable of routing data packets received from primary LEO satellite 108 along communication path D. The data packets are routed thorough Internet 116, gateway 118, secondary GEO satellite 104 to the intended recipient remote user 112.

Referring now to FIG. 1, primary LEO satellite 108 is also communicably linked to primary GEO satellite 102 along communication path E. Primary GEO satellite 102 is a part of the satellite constellation that includes secondary GEO satellite 104. Primary GEO satellite 102 is configured to receive data from LEO 108 and deliver said data packets to secondary GEO satellite 104 that is closest to the intended recipient remote wireless handset user 112 along communication path C.

Gateway 114 is capable of translating received data packets into IP format for transmission via Internet 116. Gateway 114 is also communicably coupled to primary GEO satellite 102 along communication path C. Primary GEO satellite 102 is part of the satellite constellation that includes secondary GEO satellite 104. Primary GEO satellite 102 is configured to receive data packets from gateway 114 and to deliver said data packets to secondary GEO satellite 104 that is closest to the intended recipient remote user handset 112 along communication path C.

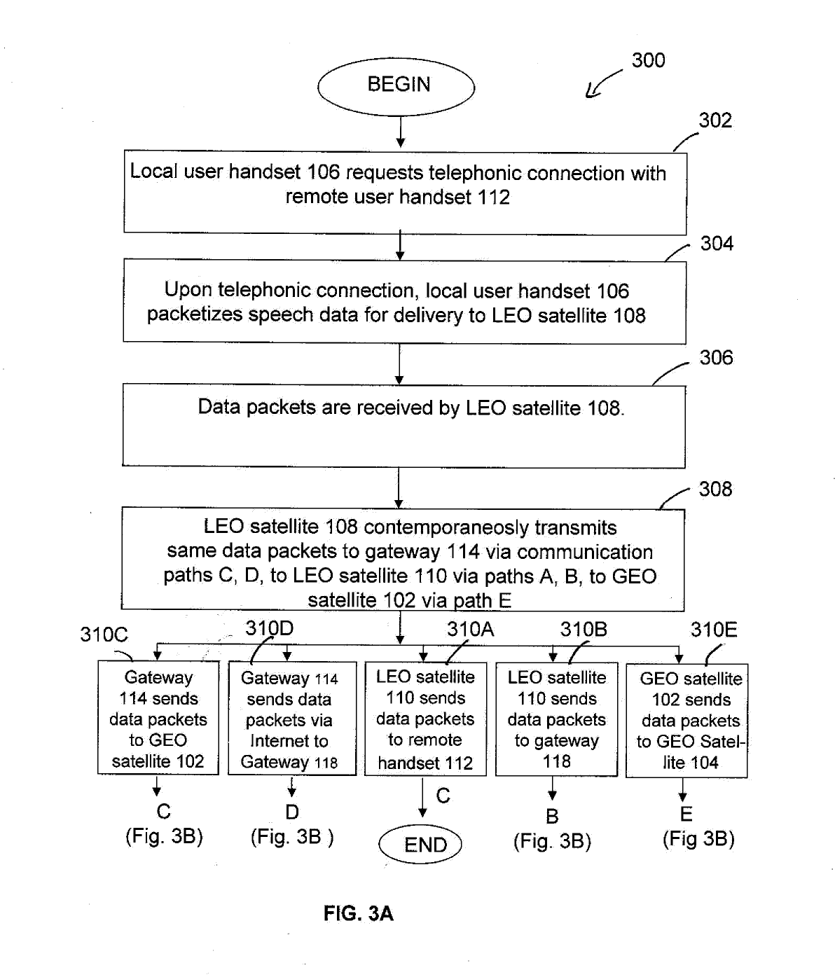

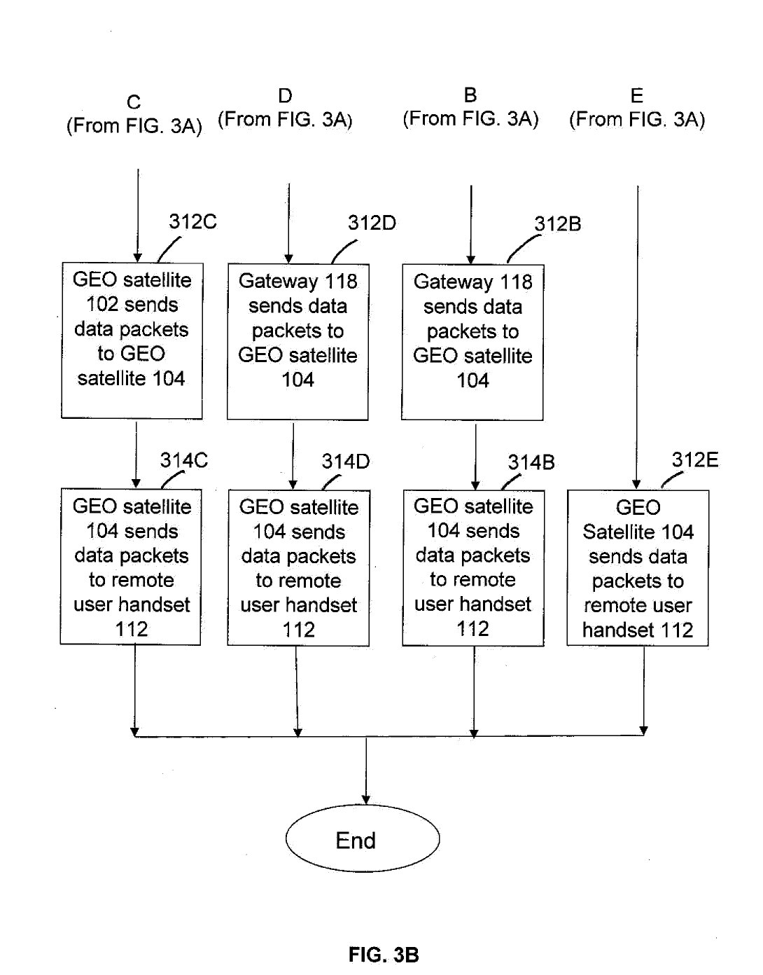

In use, to establish telephone communication, local user handset 106 uses the handset keypad (not shown) to initiate a telephone call with user 112. Once the telephone call is setup, data packets are streamed from local user handset 106 to primary LEO satellite 108. In turn, primary LEO satellite 108 streams the entirety of all of the data packets through each one of the plurality of communication paths A, B, C, D and E as more fully described with reference to FIG. 3.

Once all of the data packets are received by remote user handset 112, duplicate data packets are identified and discarded as appropriate. Another advantage of the present invention is that the entirety of all of the data packets is streamed through each of a plurality of communication paths A, B, C, D and E. Not only does this provide redundancy and path diversity in the event of data loss, it allows for increased throughput for bandwidth intensive data.

Although not shown, other type communication links might be utilized as well. The indicated communication paths shown in FIG. 1 are not intended to limit the applicability of the present invention. Further, although not shown, the return communication path from remote user handset 112 to local user handset 106 is the reverse of the communication links indicated in FIG. 1. For example, data packets from remote user handset 112 might be streamed to secondary LEO satellite 110, which becomes the primary LEO satellite from which all of the data packets from remote user handset 112 are streamed through the various multiple paths to local user handset 106.

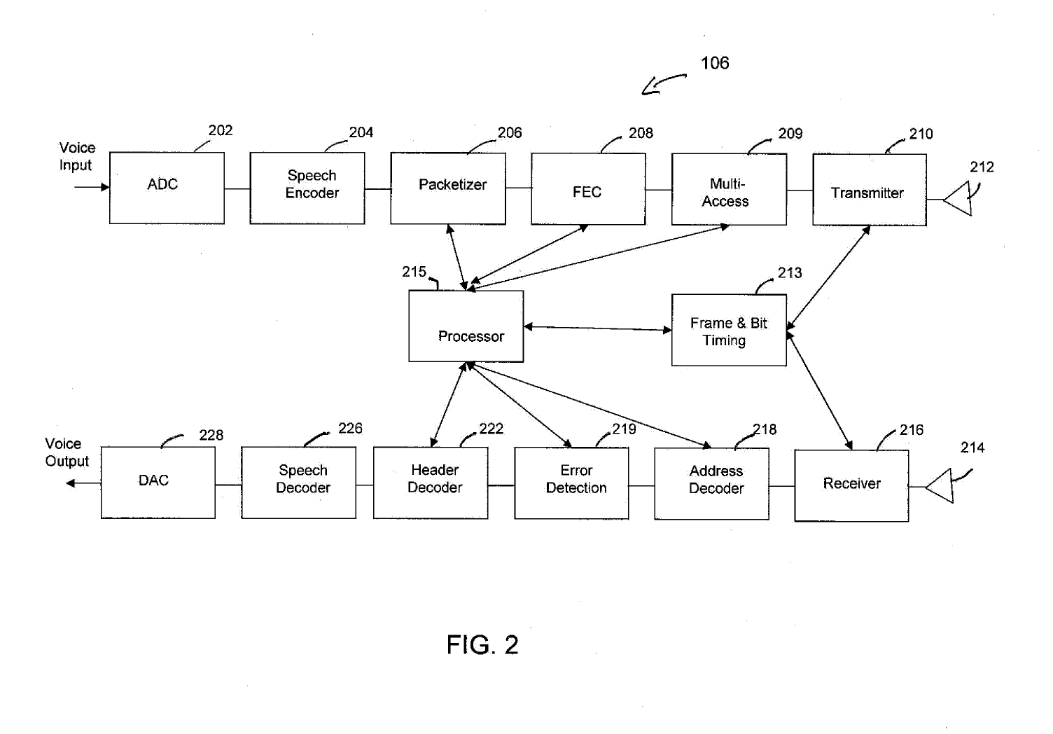

FIG. 2 is a block diagram illustrating components of local user handset 106 in accordance with an exemplary embodiment of the present invention.

In FIG. 2, local user handset 106 comprises ADC (Analog to Digital Converter) 202. ADC 202 performs a sample and hold operation preferably by sampling the user's voice signal at a rate of 64 kbps, and then thereafter performing quantization as well. The bit stream output from ADC 202 is passed to speech encoder 204 to produce digitally encoded speech that is then forwarded to packetizer 206. Packetizer 206 packetizes the voice signals into data packets having headers to which source and destination addresses are added. In addition to voice, audio, video, text and the like can all be packetized into a single composite data channel.

Error detection information is added by FEC (Forward Error Correction) circuitry 208. Thereafter, a multi-access protocol 209 scheme is applied to the data packets to efficiently allocate bandwith resources of primary LEO satellite 108 to which the data packets are sent. Any multi-access protocol such as FDMA (Frequency Division Multiple Access), TDMA (Time Division Multiple Access), etc. consistent with the spirit and scope of the present invention can be utilized.

Preferably, TCDMA (Time Code Division Multiple Access) is employed by the present invention. After the appropriate access protocol is applied, the data packets are transmitted by transmitter 210 in conjuction with framing and bit timing circuitry 213 and antenna 212. Here, as shown, processor 215 coordinates and controls the various handset component operations.

Similarly, data packets can be received by local user handset 106. The data packets from a LEO or GEO satellite are received by antenna 214 communicably coupled to receiver 216. After processing, receiver 216 passes the data packets to address decoder 218, which extracts identifier data in conjunction with processor 215 and framing and bit timing 213, and then forwards the data packets for error detection by error detection 219.

Header decoder 222 examines all of the data packet headers for decoding, and thereafter signalling packets are sent to processor 215 while data packets with the voice payload are resequenced and forwarded to speech decoder 226 for decoding. The digital data packets are then converted to analog voice signals by DAC 228 so that the voice signals can be perceived by the user.

Although not shown, processor 215 may be a dual processor. In this case, one processor (and associated components such as dual transmitters and receivers, not shown) is dedicated to processing LEO packets while the other processor is dedicated to processing GEO packets. In this manner, each one of the dual processors can independently process GEO or LEO packets thus achieving both download and upload speeds not attainable by conventional communication systems.

FIGS. 3A and 3B illustrate communication method 300 according to an exemplary embodiment of the present invention.

In FIGS. 3A and 3B, communication method 300 is preferably used by satellite network 100 of FIG. 1 to communicate data packets between local user handset 106 and remote user handset 112.

At block 302 of FIG. 3A, local user handset 106 sends a request for telephonic communication with remote user handset 112 to primary LEO satellite 106. Primary LEO satellite uses an established signalling scheme (known to both handsets) to signal remote user handset 112.

At block 304, once the telephone call is established, local user handset 106 packetizes speech data for transmission to primary LEO satellite 108. Other types of data namely audio, video, text, etc. can be packetized as well.

At block 306, the data packets from local user handset 106 are received by primary LEO satellite 108. Preferably, the data packets are packetized using a format compatible with primary LEO satellite 108, primary GEO satellite 102 and Internet 116. The data packets may be packetized according to DVB-S standards, for example, as discussed with reference to FIG. 1. The data packets can also be encapsulated in a format compatible with primary LEO 108 (and LEO satellite 110). In that case, translations into protocol formats appropriate for the next hop is performed by gateways 114 and 118.

At block 308, primary LEO satellite 108 uses the appropriate transponders to transmit the data packets in their entirety to LEO satellite 110 via communication paths A and B of FIG. 1. Contemporaneously, the same data packets are also transmitted to gateway 114 (communication paths C and D) and the same data packets are also transmitted to GEO satellite 102 via path E.

At block 310C, gateway 114 sends the data packets to primary GEO satellite 102. Although not shown, gateway 114 includes a routine for ensuring that data packets received are compatible with primary GEO satellite 102. If the data packets are incompatible as received, the routine in conjunction with appropriate hardware translates the data packets to a compatible format. For example, if primary GEO satellite 102 is DVB-S compatible, the routine translates incompatible data packets to DVB-S format before the data packets are transmitted to primary GEO satellite 102.

At block 312C of FIG. 3B, primary GEO satellite 102 transmits the data packets to secondary GEO satellite 104.

At block 314C, secondary GEO satellite 104 then forwards the data packets to the intended recipient namely remote user handset 112. Depending on when data packets routed through other communication paths arrive, the data packets from secondary GEO satellite 104 are either received for processing or are discarded as duplicate packets.

Returning to block 310D of FIG. 3A, having received the data packets from primary LEO satellite 108, gateway 114 transmits said data packets via Internet 114 to gateway 118.

At block 312D of FIG. 3B, gateway 118 sends the data packets to secondary GEO satellite 104.

At block 314D, secondary GEO satellite 104 then transmits the data packets to remote user handset 112. Depending on when data packets routed through other communication paths arrive, the data packets from secondary GEO satellite 104 can be either received for processing or are discarded as duplicate packets.

Returning to block 310B of FIG. 3A, having received the data packets from primary LEO satellite 108, secondary LEO satellite 110 transmits the data packets to gateway 118.

At block 312B of FIG. 3B, gateway 118 transmits the data packets to secondary GEO satellite 104.

At block 314B, secondary GEO satellite 104 then transmits the data packets to remote user handset 112. Depending on when data packets routed through other communication paths arrive, the data packets from secondary GEO satellite 104 can be either received for processing or are discarded as duplicate packets.

Returning to block 310A of FIG. 3A, having received the data packets from primary LEO satellite 108, secondary LEO satellite 110 transmits the data packets to the remote user handset 112. Depending on when data packets routed through other communication paths arrive, the data packets from secondary LEO satellite 110 can be either received for processing or are discarded as duplicate packets.

Returning to block 310E of FIG. 3A, having received the data packets from primary LEO satellite 108, primary GEO satellite 102 transmits the data packets to the secondary GEO satellite 104.

At block 312E of FIG. 3B, secondary GEO satellite 104 then transmits the data packets to remote user handset 112. Depending on when data packets routed through other communication paths arrive, the data packets from secondary GEO satellite 104 can be either received for processing or may be discarded as duplicate packets.

In this manner, the present invention streams the entirety of all of the data packets through each of a plurality of communication paths A, B, C, D & E. Not only does this provide redundancy and path diversity in the event of data loss, it allows increased throughput for bandwidth intensive data.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A satellite network for communicating data packets between a local handset and a remote handset in order to establish telephone communication between the local handset and the remote handset, the satellite network comprising:
a primary LEO satellite that receives said data packets from the local handset;
wherein upon receiving said data packets, the primary LEO satellite concurrently transmits said data packets in their entirety through each of a plurality of communication links between the primary LEO satellite and the remote handset for said telephone communication,
wherein said plurality of communication links include
a first link from the primary LEO satellite via a second LEO satellite to the remote handset,
a second link from the primary LEO satellite via one or more GEO satellites to the remote handset, and
a third communication link from the primary LEO satellite via a TCP/IP network to the remote handset.

2. The satellite network of claim 1 wherein the third link further comprises a GEO satellite communicably coupled between the TCP/IP network and the remote handset.

3. The satellite network of claim 1 wherein the first link further comprises a GEO satellite communicably coupled between the second LEO satellite and the remote handset.

4. A satellite network for communicating data packets between a local handset and a remote handset in order to establish telephone communication between the handsets, the satellite network comprising:
a primary LEO satellite that receives said data packets from the local handset; and
a plurality of communication links between the primary LEO satellite and the remote handset,
wherein upon receiving said data packets from the local handset, the primary LEO satellite concurrently transmits said data packets in their entirety through each of said plurality of communication links to the remote handset in order to establish said telephone communication, whereupon receiving said data packets, the remote handset identifies duplicate data packets and discards said duplicate data packets.

5. The satellite network of claim 4 wherein the plurality of communication links comprises a first link from the primary LEO satellite via a second LEO satellite to the remote handset.

6. The satellite network of claim 4 wherein the plurality of communication links comprises a second link from the primary LEO satellite via one or more GEO satellites to the remote handset.

7. The satellite network of claim 4 wherein the plurality of communication links comprises a third communication link from the primary LEO satellite via a TCP/IP network to the remote handset.

8. A method used by a satellite network for communicating data packets between a local handset and a remote handset in order to establish telephone communication between the handsets, said method comprising:
providing a primary LEO satellite that receives said data packets from the local handset; and
establishing a plurality of communication links between the primary LEO satellite and the remote handset,
wherein upon receiving said data packets from the local handset, the primary LEO satellite concurrently transmits said data packets in their entirety through each of said plurality of communication links to the remote handset in order to establish said telephone communication, whereupon receiving said data packets, the remote handset identifies duplicate data packets and discards said duplicate data packets.
